(19) United States
(12) Patent Application Publication
(10) Pub. No.: US 2008/0100731 A1
(43) Pub. Date: May 1, 2008

(54) System and Method for Producing and Displaying Images

(76) Inventor: Jerry Moscovitch, Toronto (CA)

Correspondence Address: MASS ENGINEERED DESIGN INC., 474 WELLINGTON STREET WEST, TORONTO, ON, M5V-1E3, US

(21) Appl. No.: 11/929,178

(22) Filed: Oct. 30, 2007

Related U.S. Application Data
(60) Provisional application No. 60/863,523, filed on Oct. 30, 2006.

(51) Int. Cl. H04N 9/09

(52) U.S. Cl. 348/262; 348/E09.006

(57) ABSTRACT

A system for producing and displaying images of a person is described. The system includes sets of cameras for capturing camera information to form K images of the person from more than one perspective. The system also includes a multi-screen display system for showing images of the person from the more than one perspective.

### CROSS REFERENCE TO RELATED APPLICATION

This application claims priority to provisional application No. 60/863,523, filed on Oct. 30, 2006.

### BACKGROUND OF THE INVENTION

A human being can normally perceive only one point of view at a time with the sense of sight. For example, a speaker can often see the person to whom he is speaking, but normally caimot see himself speaking. Moreover, if the speaker is facing that person, the speaker can see the front, but cannot simultaneously see the back or top of the person. Perhaps this is one of the reasons why most people have trouble ‘seeing’ things from different points of view.

Similarly, in a film, a scene is shot and the director uses the technique of cutting to cut back and forth between characters in the scene. Only one point of view or perspective is shown at once.

In the field of sports training, a coach may videotape an athlete during play. The coach then shows the athlete the videotape with the purpose of improving the athlete's performance. But here again, at any one time, the videotape shows an image of the athlete from only one perspective.

These examples all share the limitation of perceiving an image from only one perspective or point of view at any one time. A system and method that can remove this limitation would be fruitful in various disciplines, as outlined below.

### SUMMARY OF THE INVENTION

Described herein is a system for producing and displaying images of a person. The system includes n sets of cameras, P₁, . . . , Pₙ, where n>1, the n sets containing a total of K cameras for capturing camera information to form K images of the person from ii perspectives or points of view. Each set Pⱼ, where 1≦j≦n, includes at least one camera for capturing camera information to form at least one image of the person from a jth perspective. The system also includes a multi-screen display system for showing the K images of the person from the n perspectives. The K cameras capture the camera information at substantially the same time t₁ and the multi-screen display system shows the K images of the person at substantially the same time t₂, where t₂ is substantially the same or greater than t₁.

### BRIEF DESCRIPTION OF THE DRAWINGS

FIG. 1 shows sets of cameras included in a system for producing and displaying images in accord with the principles of the present invention.

FIG. 2 shows a multi-screen system included in a system for producing and displaying images in accord with the principles of the present invention.

### DETAILED DESCRIPTION OF INVENTION

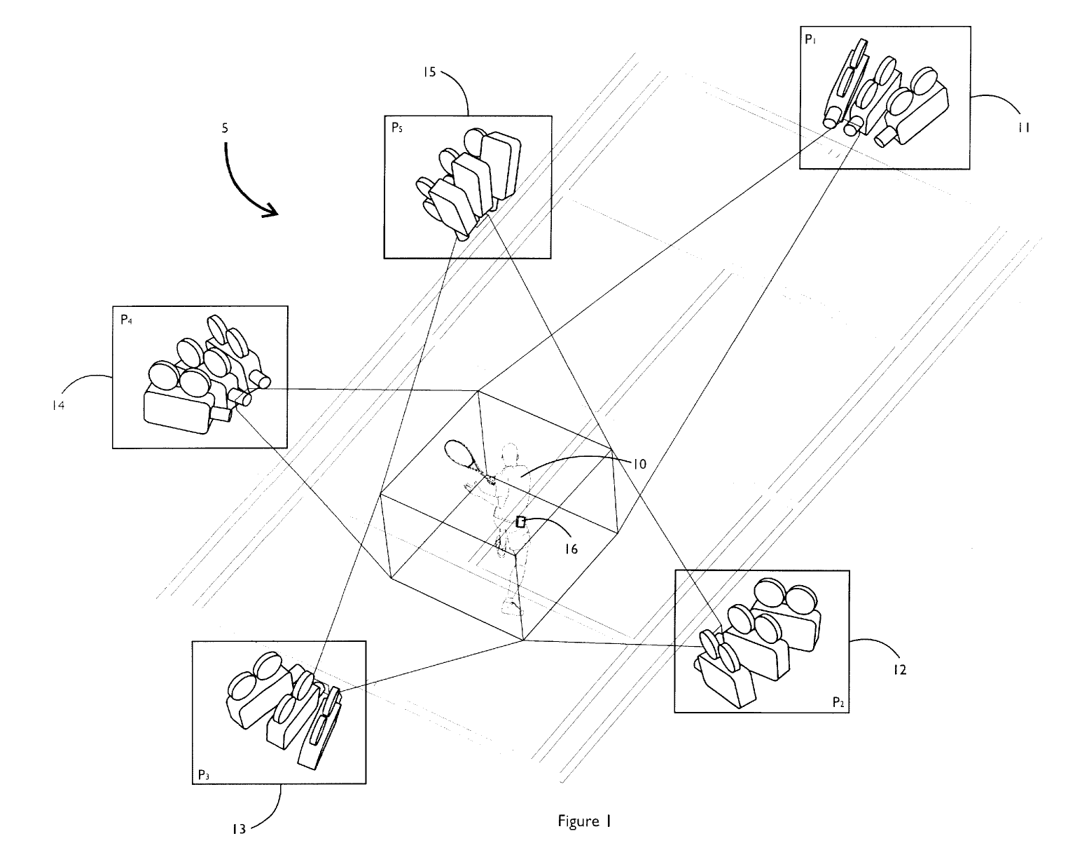

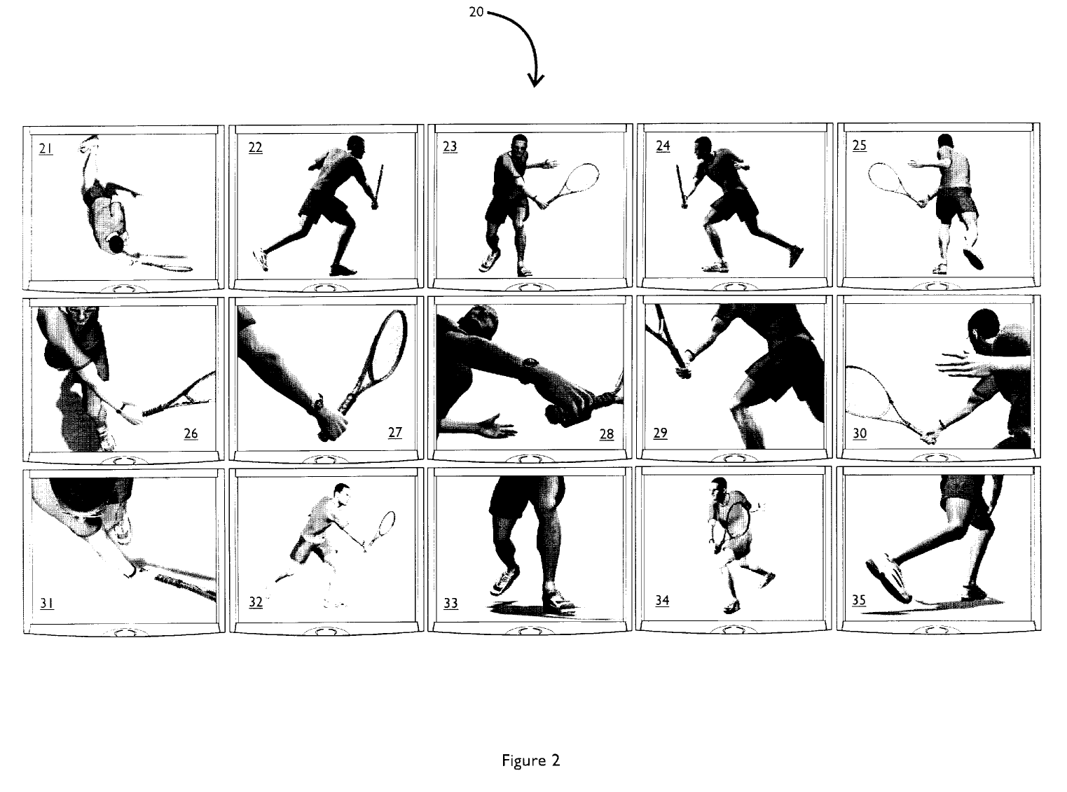

Referring to FIGS. 1 and 2, a system 5 for producing and displaying images of a person, in this example a tennis player 10, is shown. The system 5 includes five sets of cameras, P₁, . . . , P₅, numbered 11-15 in FIG. 1, for capturing camera information. In the example of FIGS. 1 and 2, each set Pⱼ, where 1≦j≦5, includes exactly three cameras. Thus, the five sets contain a total of fifteen cameras for capturing camera information to form fifteen images of the person from five perspectives. In particular, each set Pⱼ includes three cameras for capturing camera information to form images of the person from a jth perspective

Five sets, containing three cameras each, were chosen for illustrative purposes. It should be understood that more generally, the system includes n sets of cameras, Pᵢ, . . . , Pₙ, where n>1, the n sets containing a total of K cameras for capturing camera information to form K images of the person from n perspectives, each set Pⱼ, where 1≦j≦n, including at least one camera for capturing camera information to form at least one image of the person from a jth perspective. The K cameras (or in this example, five cameras) capture information of the person at substantially the same time t₁.

As shown in FIG. 2, the system 5 further includes a multi-screen display system 20 having fifteen screens 21-35 for showing the fifteen images of the person from the five perspectives. More generally, the multi-screen display system can have K screens for showing the K images of the person from the n perspectives. The multi-screen display system shows the K images at substantially the same time t₂, where t₂ is substantially the same or greater than t₁. One example of a multi-screen display system that is available commercially is the quadniple-screen display system, model number C4Q19, made by Mass Engineered Design, Inc. of Toronto, Canada.

In FIGS. 1 and 2, the five perspectives of the tennis player are a front view of the tennis player, associated with the set of cameras P₁ (element 11 in FIG. 1), a first side view, associated with the set of cameras P₂ (element 12 in FIG. 1), a back view, associated with the set of cameras P₃ (element 13 in FIG. 1), a second side view, associated with the set of cameras P₄ (element 14 in FIG. 1), and a top view, associated with the set of cameras P₅ (element 15 in FIG. 1).

The five columns of display screens in FIG. 2 correspond to the five perspectives. In particular, the images on the screens 21, 26 and 31, which form the first column, are a top view of the tennis player 10 obtained with the set of cameras P₅, numbered 15 in FIG. 1. The images on the screens 22, 27 and 32, which form the second column, are a first side view of the tennis player 10 obtained with the set of cameras P₂, numbered 12 in FIG. 1. The images on the screens 23, 28 and 33, which form the third column, are a front view of the tennis player 10 obtained with the set of cameras P₁, numbered 11 in FIG. 1. The images of the screens 24, 29 and 34, which form the fourth column, are a second side view of the tennis player 10 obtained with the set of cameras P₄, numbered 14 in FIG. 1. Finally, the screens 25, 30 and 35, which form the fifth column, are a back view of the tennis player 10 obtained with the set of cameras P₃, numbered 13 in FIG. 1.

In the example shown in FIGS. 1 and 2, each set Pⱼ includes exactly three cameras. The cameras within a set Pⱼ capture camera information of different zones or camera information at different magnifications of the player 10. For example, the set of cameras P₅ captures camera information for producing the images shown in screens 25, and 35. The screen 35 shows a bottom half of the player 10, the screen 30 shows a top half of the player, and the screen 25 shows a full view of the player 10. Moreover, the images on screens 30 and 35 are at a higher magnification than the image on screen 25.

Several other zones of the person can also be captured and shown. For example, the image on screen 29 captures a middle zone showing the waist of the player 10. The screen 28 shows a close-up of the player's hand. The screen 27 shows the player's arm.

The multi-screen system 20 of FIG. 2 has fifteen screens, each one showing exactly one image of the player. It should be understood that a multi-screen system having fewer screens than images shown may also be used. In such case, more than one image can be shown per screen. For example, in a five-screen display system, the three images in each column of FIG. 2 can instead be simultaneously shown in a single screen by allotting different portions of the screen to different images.

The cameras used in the system 5 can be still picture cameras or motion picture cameras, or cameras capable of producing both still pictures and motion pictures. Preferably, the camera is a digital camera that can produce digital signals that is readily processed by the multi-screen display system 20. Alternatively, a camera producing an analog signal can also be used. It should be understood that, where necessary, the multi-screen display system includes a computer for processing the signals to produce the images on the screens of the multi-screen display system. The multi-screen display system includes multiple electronic screens, such as CRT, LCD and/or plasma screens.

The cameras in the sets 11-15 can be capable of translating or rotating (swiveling or tilting, for example) to be able to follow the movements of the person being shot. The cameras, for example, can move on rails. In one embodiment, one or more sensors 16 placed on the person can aid in the tracking of the person, which can be done automatically or with human assistance, as known to those of ordinary skill in the art.

One or more systems like system 5 can be used to capture camera information and display images of a plurality of persons, such as athletes. For example, one person can be a novice tennis player, another person can be an accomplished tennis player, such as an elite professional tennis player. One or more multi-screen display systems, similar to the multi-screen display system 20, can show images of both tennis players next to each other as a comparison and teaching tool. Specifically, on some screens, images can be shown of the novice player executing a particular stroke, a tennis serve, for example. On some other screens, images of the elite professional athlete can be shown executing the same stroke to pin point where the novice is deviating from the elite player. In one embodiment, each screen of the multi-screen display system can be divided into two. The left side (or bottom), for example, can show the novice player, the night side (or top) can show the elite player for a convenient side-by-side comparison.

In another embodiment, one or more systems, like system 5, for producing and displaying images can be used to capture and display images of the same player at different times to measure progress. For example, one system, similar to system 5, can capture camera information of an athlete at a particular time. Likewise, another system, similar to system 5, can be used to capture camera information of the athlete one year later. The corresponding images can be shown side-by-side on two multi-screen display systems, each similar to system 20, to measure the progress that the athlete made in one year. It should be understood that instead of two systems for producing and displaying images of the athlete, only one system, similar to system 5 but with more screens, can be used. For example, instead of fifteen screens, the multi-screen display system can have thirty screens. Fifteen screens can show images similar to those shown in FIG. 2. The other fifteen screens can simultaneously show images of the same athlete shot one year later.

The system 5 described above can be used to address a limitation that frequently occurs during the course of human activity where only one perspective is available to a viewer. By utilizing system 5 for showing multiple points of view simultaneously of the same scene shot simultaneously, the brain is stimulated in a different way, resulting in a broadening of its cognitive abilities. This technique of capturing and showing video images is dubbed “multi-lobing.” Perhaps by training children in this way, when they grow up to be adults, they might perceive the world in a much broader manner.

One application of the system 5, besides the training of athletes, is in the area of filmmaking. Normally in a film, a scene is shot and the director uses the technique of cutting to cut back and forth between characters in the scene. In “multi-lobing,” a series of cameras would simultaneously shoot a scene from multiple points of view. The finished film would then be shown in a theatre having a plurality of screens (for example, three or four screens) showing the various scenes and points of view. This could also be accomplished on a desktop using a multi-screen display system.

Another application for multi-lobing is in the field of training or work motion analysis. An example discussed above is the use of muilti-lobing for the training of athletes.

In the sport of tennis, for instance, multi-lobing can be used to examine the biomechanics of a tennis player with the aim of improving athletic performance. For this purpose, a series of cameras are used to simultaneously record a competitive event or training session. In this case, the tennis court is divided into a grid system. Simultaneous viewing, of a shot from many points of view helps to better understand what the athlete is doing and how to optimize performance.

Cameras are placed to give several points of views of the player—that is, front view, back view, right and left side view, and top view. (In some applications, for example, swimming, a bottom view may also be captured.) The player can be divided into three zones, the upper body, the mid body, the lower body, producing a total of up to fifteen views of the player in a dynamic or static state.

In one embodiment, three cameras track the athlete by means of a sensor that the athlete wears. The cameras automatically track the movements of the athlete, but camera position can be overridden at any time by the coach, etc. Instead, or in addition, cameras can be programmed to record at various magnifications. For example, simultaneous images from various points of view and magnifications can be obtained of a tennis player hitting a forehand to demonstrate how all parts of the body are performing this task. One camera can capture an extreme close-up of one area, such as the hand, while at the same time other cameras can capture other images at various magnifications and from different points of view. All these cameras can record the action at various discrete times, or continuous periods of time, as the motion of the body and arm evolves. Alternatively, if the recordings can be digitalized, various magnifications can be obtained using software that can zoom in on an image to produce simultaneous images of the player at various magnifications, and various zones can be also be obtained by cropping. The athlete and coach can then link the information together and use it to improve, speed up, and increase the degree of sophistication and refinement of the training. In addition, this multi-lobing information can be used by an athletic therapist or strength training coach to train the athlete's muscles and body off-court.

FIG. 2 shows multi-lobing video data of a tennis player in one embodiment of the invention in which fifteen simultaneous images are produced of the upper, mid and lower body at various magnifications and from different points of view. FIG. 2 can represent still photographs, or snapshots at a fixed time of a continuously running movie. Thus, the cameras in FIG. 2 can be still picture cameras or motion picture cameras. The multi-lobing images shown in FIG. 2 can be used by a coach to instruct a tennis player regarding correct biomechanics, or, in digital format, can serve as input data for software that analyzes and outputs biomechanical information. For example, a multi-monitor display system showing, either in real time or with a time lag, the images of FIG. 2 can appear court-side to help analyze a tennis player's performance during a practice session.

Athletes are very dependent on coaches to tell them what they are doing wrong because, in a sense, the coach acts as the eyes of the athlete. The coach feeds back information to the athlete about where his body is and how he must adjust it. The athlete must then absorb the information and try to make adjustments without being able to see his body doing it. Thus, multi-lobing information can be useful to help train an athlete by showing in great detail the motion of an athlete during competition or practice.

As another example, consider a person who is learning aerobics or yoga. If an instructor is available, the instructor can show the student how to perform the activity, then the student can attempt to mimic the instructor's movements. The student, however, can only approximate what he is shown. If a traditional instructional video were used, then he would only be shown one view despite the fact that mastering a technique may involve the position of his hands on the ground, the width of his feet apart as they touch the ground, the arch of his back, and his head position tilted up or down or to the side. In other words, it is a series of events and movements that must occur simultaneously and in conjunction with one another that must be mastered to perform the activity properly. Showing multi-lobing images of these events at once to the person performing aerobics or yoga will speed up the learning process for both beginners and high-level practitioners.

Also, the analysis of each motion at a high magnification, such as at a magnification that clearly shows the fingertip contact and release point of a basketball, for instance, will provide the athlete with a much more scientific analysis of his performance and the factors that affect that performance.

An athlete, such as a basketball player, can be shown many simultaneous close-ups of his free throw shot at the fingertip level and at the arm release level on different occasions side by side to analyze what is different when he misses and when he sinks the shot. Of course the same multi view analysis can be done in comparison to another athlete who is more successful at the shot and then the comparison can be made in multiple views and at multiple times.

All video information can be coordinated and focused on one event in time. In the case of an athlete that is being monitored, all cameras are focused on that athlete and the number of cameras used can be at least five in number so that the athlete can be seen in motion from five different perspectives or points of view simultaneously: front view, back view, left and right side views, and top view. A fewer or a greater number of cameras can be used to record the information and multiple cameras can be disposed at different positions in each view so as to achieve three different zones for each view of the athlete's body. For example, the three zones can correspond to the athlete's upper body, mid body and lower body.

All cameras in the system can be focused exclusively on the action of the athlete being trained. If, as occurs in tennis, he is playing an opponent, then the opponent may be seen as well but the main focus of the activity is the athlete. The purpose of the cameras is to record the motion or activity of an athlete, such as hitting a tennis ball or throwing a basketball from multiple points of view simultaneously to better characterize the athlete's technique from these views. The information can be displayed on monitor screens, ideally one screen per camera point of view. Thus, for five points of view, five cameras can be used. Alternatively, if three zones are captured per view, then fifteen cameras can be used.

If, for example, fifteen monitors are utilized, then a multi-monitor display array having three rows and five columns of monitors can be used, such as shown in FIG. 2. The top row of five monitors can display five points of view at a single magnification and at a single time. The next row can show the same five points of view at the same time, but at a different magnification than the top row. And the bottom row can show still another magnification from the same points of view and at the same time. Instead of, or in addition to several magnifications, different zones of the athlete can be displayed, such as the upper body, mid-body, and lower body. More or fewer monitor screens can be used appropriately. At one magnification, the entire body of the athlete may be shown. At a different magnification, the athlete's arm can be shown, while at a third greater magnification, the fingers may be shown. The video displayed can be of still images, or a continuous stream of images (i.e., a movie) of the athlete. The images on all the monitors can be synchronized, which is to say that they all show the athlete at the same time.

Alternatively, multi-monitor system can be used to display images of the athlete at different times. For example, in a three-row by five-column multi-monitor display system, the five columns can display five different points of view, and the three rows can show the athlete from these points of view at three different times. This can be useful to examine the athlete's progress. Thus, the first row can correspond to a particular day, the next row can show the athlete a week later, and the final row can show the athlete one month later, for example.

It should be understood that the principles of the present invention can also be applied to the training of musicians and employees. Moreover, the subject shot by the cameras need not be a person, but instead can be an animal, or an inanimate object. The number of cameras within each set Pⱼ is at least one but otherwise variable. Thus, P₁ can have one camera, and P₂ can have four cameras, for instance. Within each set, the one or more cameras can capture camera information at various magnifications and/or of various zones of the subject.

What is claimed is:

1. A system for producing and displaying images of a person, the system comprising
n sets of cameras, Pᵢ, . . . , Pₙ, where n>1, the n sets containing a total of K cameras for capturing camera information to form K images of the person from n perspectives, each set Pⱼ, where 1≦j≦n, including at least one camera for capturing camera information to form at least one image of the person from a jth perspective; and
a multi-screen display system for showing the K images of the person from the n perspectives, wherein the K cameras capture the camera information at substantially the same time t₁ and the multi-screen display system shows the K images of the person at substantially the same time t₂, where t₂ is substantially the same or greater than t₁.

2. The system of claim 1, wherein n=5, and the perspectives are a first side view, a second side view, a front view, a back view and a top view.

3. The system of claim 1, wherein the cameras in the set Pⱼ, where 1≦j≦n, capture camera information of different zones of the person from the jth perspective.

4. The system of claim 3, wherein the different zones include a top portion of the person, a middle portion of the person and a bottom portion of the person.

5. The system of claim 1, wherein the cameras in the set Pⱼ, where 1≦j≦n, capture camera information of the person at different magnifications from the jth perspective.

6. The system of claim 1, wherein the multi-screen display system includes K screens for showing the K images.

7. The system of claim 1, wherein the camera is one of a motion picture camera and a still picture camera.

8. The system of claim 1, wherein the multi-screen display system includes a computer for processing the camera information to produce the K images.

9. The system of claim 1, wherein the camera is a digital camera.

10. A method for producing and displaying images of a person, the method comprising
capturing, at substantially the same time t₁, camera information using n sets of cameras, P₁, . . . , Pₙ, where n>1, the n sets containing a total of K cameras, to form K images of the person from n perspectives, each set Pⱼ, where 1≦j≦n, including at least one camera for capturing camera information to form at least one image of the person from a jth perspective; and
showing, at substantially the same time t₂, the K images of the person from the n perspectives using a multi-screen display system, where t₂ is substantially the same or greater than t₁.

11. The method of claim 10, further comprising using the multi-screen system to show a plurality of images of an additional person at the same time that the K images are shown to compare the person to the additional person.
